(19) United States
(12) Patent Application Publication
(10) Pub. No.: US 2023/0044877 A1
(43) Pub. Date: Feb. 9, 2023

(54) Selectively Changeable Kick Plate and Method of Use

(71) Applicant: Tucker R. Hiegel, Ballwin, MO (US)

(72) Inventor: Tucker R. Hiegel, Ballwin, MO (US)

(21) Appl. No.: 17/880,634

(22) Filed: Aug. 3, 2022

Related U.S. Application Data
(60) Provisional application No. 63/228,968, filed on Aug. 3, 2021.

(51) Int. Cl. G09F 7/18; E06B 7/28

(52) U.S. Cl. CPC G09F 7/18; E06B 7/28; G09F 2007/1852

(57) ABSTRACT

A method of attaching a kick plate to a lower margin of a door face. The door face extends upward from a lower edge to an upper edge. The door face has a first side edge and a second side edge opposite the first side edge. The door face has a door face height and a door face width. The method includes orienting a kick plate assembly having a front face and a magnetic back face so the back face faces the door face. The kick plate assembly is centered generally evenly between the first side edge and the second side edge, and a bottom edge of the kick plate assembly is aligned generally parallel to the lower edge of the door face. The magnetic back face of the kick plate assembly is magnetically joined to the door face so the kick plate assembly is selectively separable from the door.

### REFERENCE TO RELATED APPLICATIONS

The present application claims priority of co-pending U.S. Provisional Application No. 63/228,968 filed Aug. 3, 2021, and entitled, “Selectively Changeable Kick Plate,” which is hereby incorporated by reference.

### BACKGROUND

The present disclosure relates to kick plates for doors, and more particularly, to a kick plate that is selectively changeable or replaceable with an alternative kick plate without removing screw fasteners.

Kick plates are installed on lower margins of doors for decoration and to prevent a corresponding surface of the door from being marred during use. Typically, kick plates are made of metal sheet and are sized to cover a lower portion of the door. In many instances, the kick plates are sized to extend substantially between side edges of the door face, leaving a small, e.g., about ⅛ inch to about ½ inch border space between the sides of the kick plate and the corresponding side edges of the door face. Although the kick plates may extend farther upward, in most instances the kick plates are about 8 inches to about 12 inches tall and are spaced from the lower edge of the door face by a distance of about ⅛ inch to about 1 inch. As the kick plates are intended to be attached permanently, they are typically held in place on the door face by screw fasteners extending through holes provided around a margin of the of the kick plate for this purpose.

Because conventional kick plates are made from metal, upkeep is minimal except on doors mounted in high traffic areas, such as commercial installations. If desired, most scratches and other surface defects may be periodically cleaned and polished without removing the kick plate. After extended use, the kick plate may be replaced for cosmetic reasons but frequently kick plates remain in place on the door for the entire life of the door.

Some users may want to change kick plates more often. For example, commercial users may want to use the space to promote sales or other events. Residential users may want to periodically change the appearance of the kick plate, e.g., to correspond with the season or holiday being celebrated. Although conventional kick plates may be replaced from time to time, this typically requires unscrewing the kick plate from the door and fastening a different kick plate to the door. Changing the kick plate for limited periods is normally viewed as requiring too much effort and expense. Therefore, this potential promotional and decorative space is unrealized. Accordingly, there is a need for kick plates that are selectively changeable without the need for removing fasteners or other permanent mounting means.

### SUMMARY

In one aspect, this disclosure includes a method of attaching a kick plate to a lower margin of a door face adjacent to a lower edge of the door face. The door face extends upward from the lower edge to an upper edge opposite the lower edge. The door face has a first side edge extending from the lower edge to the upper edge and a second side edge extending from the lower edge to the upper edge opposite the first side edge. The door face has a door face height measured from the lower edge to the upper edge and a door face width measured from the first side edge to the second side edge. The method comprises orienting a kick plate assembly having a front face and a magnetic back face, so the magnetic back face faces the door face. The kick plate assembly is centered generally evenly between the first side edge and the second side of the door face, and a bottom edge of the kick plate assembly is aligned generally parallel to the lower edge of the door face. The method also includes contacting the magnetic back face of the kick plate assembly to the door face to magnetically join the kick plate assembly to the door face, so the kick plate assembly is selectively separable from the door.

In another aspect, this disclosure includes a selectively changeable kick plate for protecting a lower margin of a door face adjacent to a lower edge of the door face. The door face extends upward from the lower edge to an upper edge opposite the lower edge. The door face has a first side edge extending from the lower edge to the upper edge and a second side edge extending from the lower edge to the upper edge opposite the first side edge. The door face has a door face height measured from the lower edge to the upper edge and a door face width measured from the first side edge to the second side edge. The kick plate comprises an outer layer having a layer front face and a layer back face opposite the layer front face. The outer layer spans a horizontal layer width equal to more than about 90% of the door face width and a vertical layer height less than about 18 inches; and a magnetic sheet attached to the layer back face.

In yet another aspect, this disclosure includes a set of selectively changeable kick plates comprising a plurality of kick plates for selectively attaching to a lower margin of a door face adjacent to a lower edge of the door face. The door face extends upward from the lower edge to an upper edge opposite the lower edge. The door face having a first side edge extending from the lower edge to the upper edge and a second side edge extending from the lower edge to the upper edge opposite the first side edge. The door face has a door face height measured from the lower edge to the upper edge and a door face width measured from the first side edge to the second side edge. Each kick plate of the plurality of kick plates comprises an outer layer having a layer front face and a layer back face opposite the layer front face. The outer layer spans a horizontal layer width in a layer width range of about ¼ inch to about 1 inch less than the door face width and a layer height in a layer height range of about 8 inches to about 12 inches. Each kick plate of the plurality of kick plates also comprises a magnetic sheet attached to the layer back face having a horizontal magnetic sheet width substantially equal to the horizontal layer width and a vertical magnetic sheet height substantially equal to vertical layer height.

### BRIEF DESCRIPON OF DRAWINGS

FIG. 1 is a front elevational view of a door having a kick plate of a first example;

FIG. 2 is a cross section of the door and kick plate of FIG. 1 taken in the plane of line 2-2 of FIG. 1;

FIG. 3 is a detail of an area inscribed by a corresponding circle in FIG. 2;

FIG. 4 is a front elevation al view of a door having a kick plate of a second example;

FIG. 5 is a cross section of the door and kick plate of FIG. 4 taken in the plane of line 5-5 of FIG. 4; and

FIG. 6 is a detail of an area inscribed by a corresponding circle in FIG. 5.

Corresponding reference characters indicate corresponding parts throughout the drawings.

### DETAILED DESCRIPTION

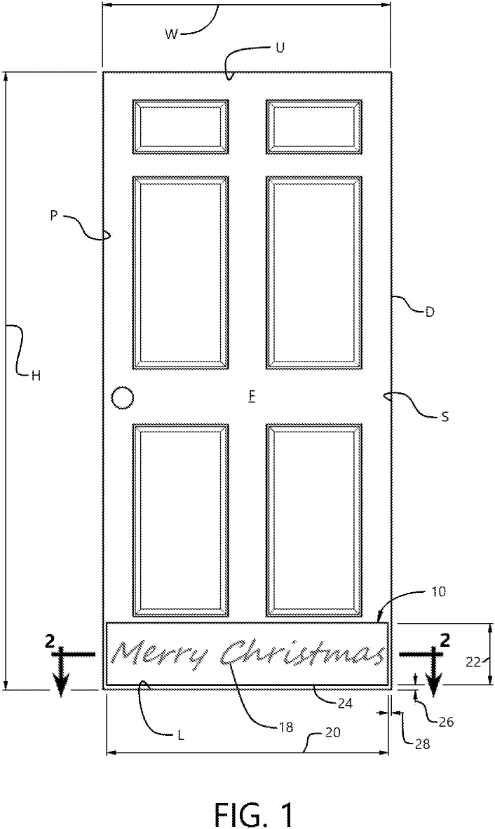

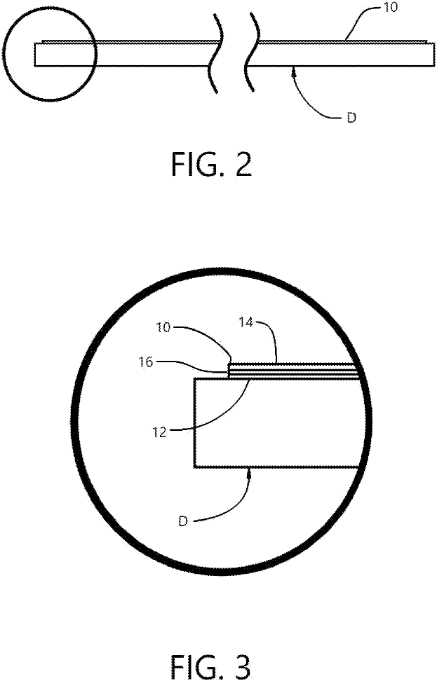

As illustrated in FIGS. 1-3, a first example of a kick plate assembly is designated in its entirety by the reference number 10. The kick plate assembly 10 is configured for use on a conventional metal door D constructed from a ferromagnetic material such as steel sheet to which magnetic materials are attracted. The door D has a surface or face F to which the kick plate assembly 10 is a magnetically joined as will be explained. Further, the face F has a lower edge L, an upper edge U opposite the lower edge, and a height H measured between the lower edge and upper edge. The face F also has first and second edges P, S, respectively, extending between the lower edge L and upper edge U, and a width W measured between the first edge and the second edge. As illustrated in FIG. 3, the kick plate assembly 10 of the first example comprises a plurality of layers, including a magnetic layer 12 that attracts the kick plate assembly 10 to the ferromagnetic door D and a protective and/or decorative outer layer 14 joined to the magnetic layer or sheet 12 by an adhesive layer 16. Although the outer layer 14 may be made from any suitable material such as sheet vinyl, the outer layer of the illustrated kick plate assembly is made of polished brass sheet or aluminum sheet. Further, the outer layer 14 may have various conventional surface treatments including grit blasting, painting, anodizing, and coating. In addition, the outer layer 14 may include a message or other decoration 18 as shown in FIG. 1. In some examples, the message or other decoration is made using vinyl applique or by etching the outer layer 14. The decoration 18 may include a seasonal message such as “Happy Halloween”, a commercial message such as “50% Off Sale”, or residential messages such as “The Jones” or “Welcome”.

In some examples, the outer layer 14 has a horizontal layer width 20 equal to more than about 90% of the door face width W and a vertical layer height 22 of less than 18 inches. However, in the illustrated example the outer layer 14 has a width 20 in a range of about ¼ inch to about 1 inch less than the door face width W. For example, the outer layer 14 of a kick plate assembly 10 made for a door having a face width W of 30 inches may have a layer width 20 of about 29 inches. The illustrated outer layer 14 has a vertical layer height 22 is in a range of about 8 inches to about 12 inches. In some examples, more than one magnetic layer 12 and adhesive layer 16 may be applied to the outer layer 14, but in most examples, only one magnetic layer and one adhesive layer are applied to the outer layer. In these examples, both the magnetic layer 12 and the adhesive layer 16 have widths and heights of no less than 90% of the corresponding dimension of the outer layer 14. In the illustrated example, the magnetic layer 12 and the adhesive layer 16 each has a width substantially equal to the horizontal width of the outer layer 14 and a height substantially equal to vertical height of the outer layer.

To use the kick plate assembly 10, the user positions the kick plate assembly adjacent a lower margin of the ferromagnetic door D and contacts the magnetic layer 12 to the door. The magnetic layer 12 of the kick plate assembly 10 is magnetically held in position once applied. More precisely, the user orients the selected kick plate assembly 10 so its magnetic layer 12 or its magnetic back face faces the door face F. Once the kick plate assembly 10 is properly oriented, the user centers the kick plate assembly generally evenly between the first side edge F and the second side edge S of the door face D and aligns a bottom edge 24 of the kick plate assembly generally parallel to the lower edge L of the door face. Although the bottom edge 24 may be spaced from the lower edge L of the door face F by other distances, the bottom edge of the illustrated kick plate assembly 10 is spaced from the lower edge of the door face by a vertical distance 26 in a range of about ⅛ inch and about 1 inch. Likewise, although the side edges of the kick plate assembly 10 may be spaced from the side edges P, S of the door face F by other distances, the side edges of the illustrated kick plate assembly are spaced from the side edge of the door face by a horizontal distance 28 in a range of about ⅛ inch and about ½ inch.

It is envisioned that the precise position of the kick plate assembly 10 may be adjusted once the kick plate is magnetically attached to the door. To change the kick plate 10, the user separates the kick plate assembly from the door D. An alternative kick plate assembly 10 may be installed on the door face using the previously described procedure or the door may be left bare. Although the kick plate assembly 10 is described as having one decorative layer 14, it is envisioned that the kick plate assembly may be configured with a second decorative layer on its opposite face so the appearance of the door D may be altered by separating the kick plate assembly from the door and flipping the assembly, so its opposite face is exposed before reapplying the assembly to the door face as previously described.

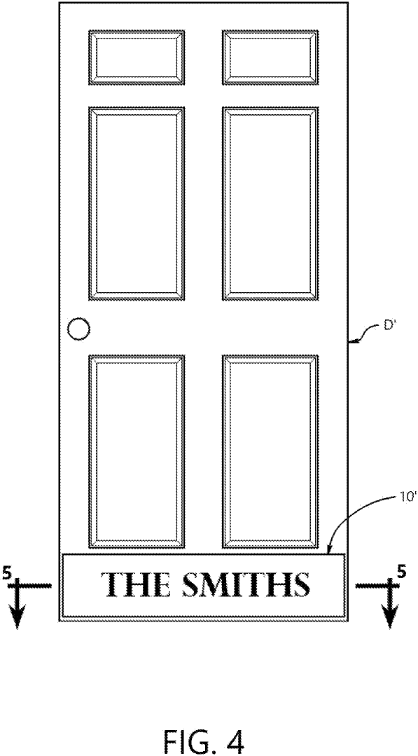

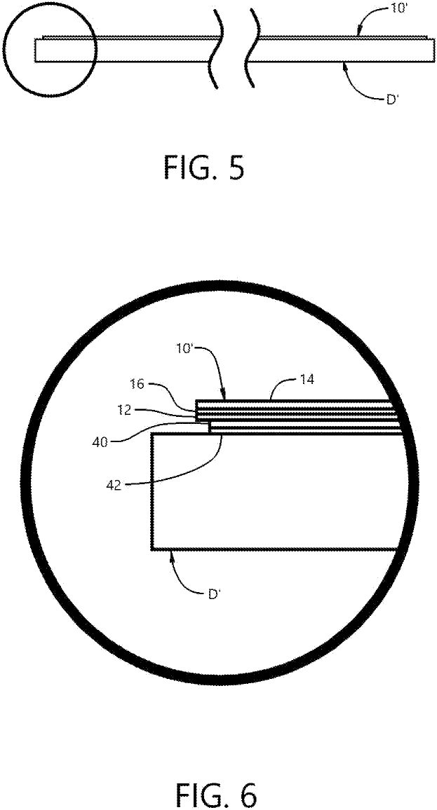

A conventional door D′, which may be made of ferromagnetic or non-ferromagnetic material is shown in FIGS. 4-6. The door D′ may be modified for use with the previously described kick plate assembly 10. A ferromagnetic or magnetized connector sheet 40 is applied to the door D′. Although the connector sheet 40 may be joined by other suitable means, an adhesive layer 42 is used in the illustrated example to attach the connector sheet 40 to the D′. Although other adhesives may be used, the illustrated adhesive layer 42 comprises TTL-3671 double coated UPVC film tape available from The Tape Lab of Dana Point, California. This adhesive film tape has been found to provide a strong bond capable of supporting the weight of the connector sheet 40 and kick plate assembly 10 over an extended period of time. It is also envisioned that the kick plate assembly 10 may overlay and be magnetically joined to an existing ferromagnetic kick plate on a door D′. Once the connector plate 40 is mounted on the door D′, the kick plate assembly 10 is attached to the connector sheet 40 as described above with respect to the ferromagnetic door D. In the illustrated example, the ferromagnetic sheet 40 comprises a 24 gauge galvanized steel sheet, which provides for a strong magnetic bond between the sheet 40 and the kick plate assembly 10. Although the connector sheet 40 may have other dimensions, in the illustrated example the connector sheet has a horizontal sheet width about ¼ inch less than the horizontal outer layer width and a vertical sheet height about ¼ inch less than the vertical outer layer height. These dimensions allow the kick plate assembly 10 to completely cover the connector sheet 40 without requiring each edge to precisely match the corresponding edge of the connector sheet. The kick plate assembly 10, adhesive layer 42, and connector sheet 40 may be sold as a unit (i.e., a kick plate assembly 10').

When introducing elements of the present invention as described in any appended claims or the previously described examples, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense. Any additional subject matter not within the scope of the claims is not dedicated to the public and the right to file one or more applications to claim such additional subject matter is reserved.

1. A method of attaching a kick plate to a lower margin of a door face adjacent to a lower edge of the door face, the door face extending upward from the lower edge to an upper edge opposite the lower edge, the door face having a first side edge extending from the lower edge to the upper edge and a second side edge extending from the lower edge to the upper edge opposite the first side edge, the door face having a door face height measured from the lower edge to the upper edge and a door face width measured from the first side edge to the second side edge, said method comprising:
orienting a kick plate assembly having a front face and a magnetic back face so the magnetic back face faces the door face;
centering the kick plate assembly generally evenly between the first side edge and the second side edge of the door face;
aligning a bottom edge of the kick plate assembly generally parallel to the lower edge of the door face; and
magnetically joining the kick plate assembly to the door face so the kick plate assembly is selectively separable from the door face.

2. A method of attaching a kick plate to a face of a door as set forth in claim 1, wherein said kick plate assembly is a first kick plate assembly and said method further comprises:
removing said first kick plate assembly from the door;
orienting a second kick plate assembly having a front face and a magnetic back face so the back face faces the door face;
centering the second kick plate assembly generally evenly between the first side edge and the second side edge of the door face;
aligning a bottom edge of the second kick plate assembly generally parallel to the lower edge of the selectively changeable kick plate for attaching to lower edge of the door face; and
magnetically joining the kick plate assembly to the door face so the second kick plate assembly is selectively separable from the door face.

3. A method of attaching a kick plate to a face of a door as set forth in claim 1, further comprising, before the steps of orienting, centering, aligning, and joining:
centering a ferromagnetic sheet generally evenly between the first side edge and the second side edge of the door face;
aligning a bottom edge of the ferromagnetic sheet generally parallel to the lower edge of the door face; and
attaching the centered and aligned ferromagnetic sheet to the door face adjacent the lower edge of the door face; and
wherein the step of magnetically joining the kick plate assembly to the door face comprises contacting the magnetic back face to the attached ferromagnetic sheet.

4. A method of attaching a kick plate to a face of a door as set forth in claim 1, wherein the step of aligning bottom edge of the kick plate assembly includes spacing the bottom edge of the kick plate assembly from the lower edge of the door face by a distance in a vertical spacing range of about ⅛ inch and about 1 inch.

5. A method of attaching a kick plate to a face of a door as set forth in claim 1, wherein the step of centering the kick plate assembly includes spacing a first side edge of the kick plate assembly from the first side edge of the door face by a distance in a horizontal spacing range of about ⅛ inch and about ½ inch.

6. A selectively changeable kick plate for protecting a lower margin of a door face adjacent to a lower edge of the door face, the door face extending upward from the lower edge to an upper edge opposite the lower edge, the door face having a first side edge extending from the lower edge to the upper edge and a second side edge extending from the lower edge to the upper edge opposite the first side edge, the door face having a door face height measured from the lower edge to the upper edge and a door face width measured from the first side edge to the second side edge, said kick plate comprising:
an outer layer having a layer front face and a layer back face opposite the layer front face, said outer layer spanning a horizontal layer width equal to more than about 90% of the door face width and a vertical layer height less than about 18 inches; and a magnetic sheet attached to the layer back face.

7. A selectively changeable kick plate as set forth in claim 6, wherein the vertical layer height is in a layer height range of about 8 inches to about 12 inches.

8. A selectively changeable kick plate as set forth in claim 6, wherein the horizontal layer width is in a layer width range of about ¼ inch to about 1 inch less than the door face width.

9. A selectively changeable kick plate as set forth in claim 6, further comprising an adhesive layer attaching the magnetic sheet to the layer back face.

10. A selectively changeable kick plate as set forth in claim 6, wherein the magnetic sheet has a horizontal magnetic sheet width equal to more than about 90% of the horizontal layer width and a vertical magnetic sheet height equal to more than about 90% of the vertical layer height.

11. A selectively changeable kick plate as set forth in claim 10, wherein the magnetic sheet has a horizontal magnetic sheet width substantially equal to the horizontal layer width and a vertical magnetic sheet height substantially equal to vertical layer height.

12. A selectively changeable kick plate as set forth in claim 6, further comprising a ferromagnetic sheet to which the magnetic sheet is attracted, said ferromagnetic sheet being adapted for attachment to the lower margin of the door face adjacent to the lower edge of the door face for magnetically attaching the magnetic sheet thereto so the layer front face faces away from the door face.

13. A selectively changeable kick plate as set forth in claim 12, wherein:
the magnetic sheet has a horizontal magnetic sheet width equal to more than about 90% of the horizontal layer width and a vertical magnetic sheet height equal to more than about 90% of the vertical layer height; and
the ferromagnetic sheet has a horizontal ferromagnetic sheet width equal to more than about 90% of the horizontal layer width and a vertical ferromagnetic sheet height equal to more than about 90% of the vertical layer height.

14. A selectively changeable kick plate as set forth in claim 13, wherein:
the magnetic sheet has a horizontal magnetic sheet width substantially equal to the horizontal layer width and a vertical magnetic sheet height substantially equal to vertical layer height; and
the ferromagnetic sheet has a horizontal ferromagnetic sheet width about ¼ inch less than the horizontal magnetic sheet width and a vertical ferromagnetic sheet height about ¼ inch less than the vertical magnetic sheet height.

15. A selectively changeable kick plate as set forth in claim 12, further comprising an adhesive film attached to the ferromagnetic sheet for bonding the ferromagnetic sheet to the face of the door adjacent the lower edge.

16. A set of selectively changeable kick plates comprising a plurality of kick plates for selectively attaching to a lower margin of a door face adjacent to a lower edge of the door face, the door face extending upward from the lower edge to an upper edge opposite the lower edge, the door face having a first side edge extending from the lower edge to the upper edge and a second side edge extending from the lower edge to the upper edge opposite the first side edge, the door face having a door face height measured from the lower edge to the upper edge and a door face width measured from the first side edge to the second side edge, each kick plate of said plurality of kick plates comprising:
an outer layer having a layer front face and a layer back face opposite the layer front face, said outer layer spanning a horizontal layer width in a layer width range of about ¼ inch to about 1 inch less than the door face width and a layer height in a layer height range of about 8 inches to about 12 inches; and
a magnetic sheet attached to the layer back face having a horizontal magnetic sheet width substantially equal to the horizontal layer width and a vertical magnetic sheet height substantially equal to vertical layer height.

17. A set of selectively changeable kick plates as set forth in claim 16, further comprising a ferromagnetic sheet to which the magnetic sheet is attracted, said ferromagnetic sheet being adapted for attachment to the face of the door adjacent the lower edge of the face door for magnetically attaching the magnetic sheet of a selected kick plate of said plurality of kick plates thereto so the layer front face of the selected kick plate faces away from the door face.

18. A set of selectively changeable kick plates as set forth in claim 17, further comprising an adhesive film attached to the ferromagnetic sheet for bonding the ferromagnetic sheet to the face of the door adjacent the lower edge.
